(19) United States
(12) Patent Application Publication
(10) Pub. No.: US 2012/0050536 A1
(43) Pub. Date: Mar. 1, 2012

(54) SYSTEM AND METHOD FOR REMOTE FOCUS IN NIGHT VISION SYSTEMS

(75) Inventors: BLAIR REUBEN DOBBIE, Roanoke, VA (US); Timothy Krahn Trudeau, Roanoke, VA (US)

(73) Assignee: ITT MANUFACTURING ENTERPRISES, INC., WILMINGTON, DE (US)

(21) Appl. No.: 12/869,090

(22) Filed: Aug. 26, 2010

(51) Int. Cl. H04N 5/335; G02B 7/08

(52) U.S. Cl. 348/162; 359/811; 348/E05.091

(57) ABSTRACT

Focusing systems and methods for remotely controlling a focal position of an objective lens assembly in a night vision optical device are provided. The focusing system includes a focusing device and a focus selector. The focusing device includes an objective lens assembly positioned among two or more focus positions from an imaging array and a focus controller, coupled to the objective lens assembly, configured to translate the objective lens assembly relative to the imaging array among the two or more focus positions. The focus selector is remote from the focusing device and is configured to wirelessly transmit a selected focus position to the focus controller. The objective lens assembly is translated to one of the two or more focus positions in response to the selected focus position transmitted by the focus selector.

### FIELD OF INVENTION

The present invention relates to a remote focusing system for use with an optical device, particularly suited for night vision applications.

### BACKGROUND OF THE INVENTION

Night vision systems are used in a wide variety of military, industrial and residential applications to enable sight in a dark environment. For example, night vision systems are utilized by military aviators during nighttime flights or military soldiers patrolling the ground. As another example, security cameras use night vision systems to monitor dark areas.

Conventional image enhancement night vision equipment utilize an image intensifier (I²) to amplify an image. The image intensifier collects tiny amounts of light in a dark environment, including the lower portion of the infrared light spectrum, that are present in the environment but may be imperceptible to the human eye. The image intensifier amplifies the light so that the human eye can perceive the image. The light output from the image intensifier can either be supplied to a camera, an external monitor or directly to the eyes of the viewer. Image intensifier devices are commonly used in night vision goggles, i.e., a monocular or binocular, that are worn on a user's head for transmission of light output directly to the viewer.

Unlike conventional night vision systems, conventional imaging systems typically include an autofocus device, in order to provide an optimally focused image to the user. Conventional autofocus devices include an objective lens, an electronic imaging device (such as a charge coupled device (CCD) or complementary metal oxide semiconductor (CMOS) circuit), an electro-mechanical driver for positioning the objective lens relative to the imaging device and an electronic processor that performs real-time image analysis. In operation, the electronic processor determines a suitable focus adjustment based on the real-time image analysis. The electronic processor sends focus commands to the electro-mechanical driver to position the objective lens for optimal focusing of the image.

The processor continually analyzes the image such that the driver, responsive to the processor, may adjust the objective lens over a wide range of focus positions. Accordingly, in order to perform optimal focusing, continuous electrical power is generally provided to the autofocus components. In a conventional application, the power provided to the autofocus components may represent a significant percentage of the available power. For applications that are carried by an individual and are battery operated, the total operating time provided from a single battery charge may be strongly influenced by the power consumption by the autofocus device. In addition, the weight of existing autofocus devices, in particular, the weight of the electro-mechanical driver and battery components, tends to reduce the mobility of the observer. For at least these reasons, autofocus devices are typically not included with conventional night vision systems.

### SUMMARY OF THE INVENTION

The present invention relates to a focusing system for use with a night vision optical device. The focusing system includes a focusing device and a focus selector. The focusing device includes an objective lens assembly positioned among two or more focus positions from an imaging array, and a focus controller, coupled to the objective lens assembly, configured to translate the objective lens assembly relative to the imaging array among the two or more focus positions. The focus selector is remote from the focusing device and is configured to wirelessly transmit a selected focus position to the focus controller. The objective lens assembly is translated to one of the two or more focus positions in response to the selected focus position transmitted by the focus selector.

The present invention also relates to a night vision optical device. The night vision optical device includes an objective lens assembly positioned among two or more focus positions from an imaging array, and a focus controller that is coupled to the objective lens assembly. The focus controller includes a receiver configured to receive a selected focus position wirelessly transmitted from a focus selector that is remote from the focus controller, and a lens positioner coupled to the objective lens assembly for translating the objective lens assembly responsive to the received focus position. The focus controller is configured to translate the objective lens assembly relative to the imaging array to one of the two or more focus positions responsive to the received focus position.

The present invention further relates to a method for controlling a focal position of an objective lens assembly positioned from an imaging array in a focusing device of a night vision optical device. The method includes (a) wirelessly signaling one of two or more focus positions to the focusing device from a device remote from the night vision optical device; (b) receiving the signaled focus position by the focusing device; and (c) translating the objective lens assembly relative to the imaging array to the received focus position.

### BRIEF DESCRIPTION OF THE DRAWINGS

The invention may be understood from the following detailed description when read in connection with the accompanying drawing. Included in the drawing are the following figures:

FIG. 1 is a block diagram illustrating a position of a focal plane relative to an objective lens for objects at different distances from the objective lens;

FIG. 2 is a cross-section diagram of a remote focusing system according to an exemplary embodiment of the present invention;

FIGS. 3A and 3B are cross-section diagrams of the remote focusing system shown in FIG. 2 as part of a night vision optical device, illustrating positioning of the objective lens assembly for distant and near objects, respectively, according to exemplary embodiments of the present invention;

FIG. 4 is a block diagram of a focus controller and a remote focus selector included in the remote focusing system shown in FIG. 2, according to an exemplary embodiment of the present invention; and

FIG. 5 is a block diagram of a night vision optical device configured to receive focus positions from a remote focus selector, according to an exemplary embodiment of the present invention.

### DETAILED DESCRIPTION OF THE INVENTION

The invention will next be illustrated with reference to the figures. Such figures are intended to be illustrative rather than limiting and are included herewith to facilitate explanation of the present invention. The figures are not to scale, and are not intended to serve as engineering drawings.

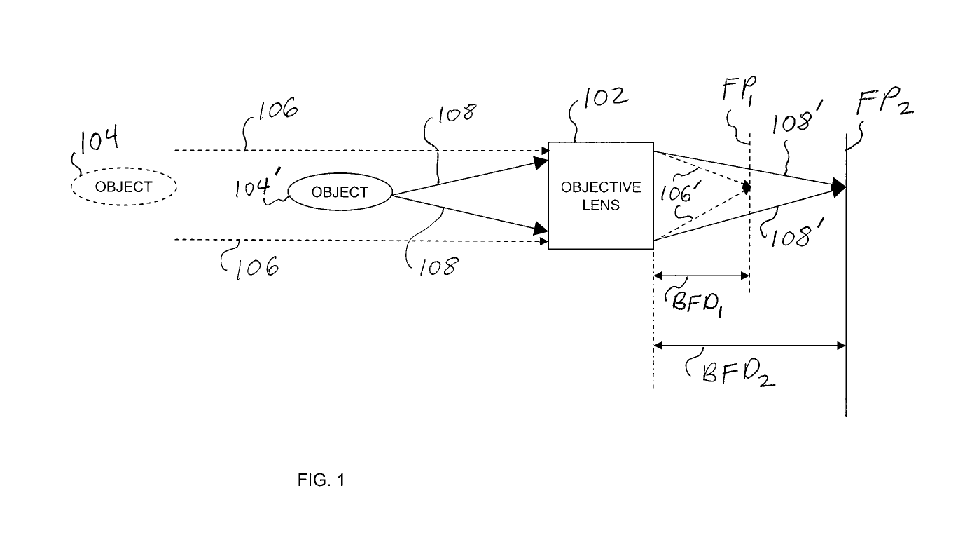

Referring to FIG. 1, a block diagram illustrating a position of a focal plane (FP) FP₁ (or FP₂) relative to objective lens 102 for object 104 (or object 104′) at different distances from the objective lens. Objective lens 102 represents a general objective lens, and may include one or more optical lens elements. In general, objective lens 102 passes light rays 106 (or light rays 108) from object 104 (or object 104′) and produces light rays 106′ (or light rays 108′) that converge onto FP₁ (or FP₂). The focal plane represents the position of the focused image of an object. Typically, the focal plane represents the position of an imaging array (not shown), such as a CCD detector, or a CMOS detector.

In FIG. 1 two different conditions for focusing are illustrated. A first condition corresponds to object 104 located far from objective lens 102. Object 104 is illustrated as being located far enough away from objective lens 102 to be considered to be at infinity. Light rays 106 from object 104 are generally parallel light rays as they reach objective lens 102. Light rays 106 pass through objective lens 102 to form light rays 106′ that converge at FP₁. The FP₁ is located at a back focus distance (BFD) of BFD₁.

A second condition corresponds to object 104′ located near objective lens 102. Object 104′ is illustrated as being relatively close to objective lens 102 (i.e., not at infinity focus) to produce light rays 108 that diverge as they reach objective lens 102. Light rays 108 pass through objective lens 102 to form light rays 108′ that converge at FP₂. The FP₂ is located at BFD₂. It may be appreciated that the first focal plane FP₁ is closer to objective lens 102 as compared with the second focal plane FP₂ and that objects 104, 104′ are brought to focus at different back focus distances BFD₁, BFD₂ in the image space of objective lens 102.

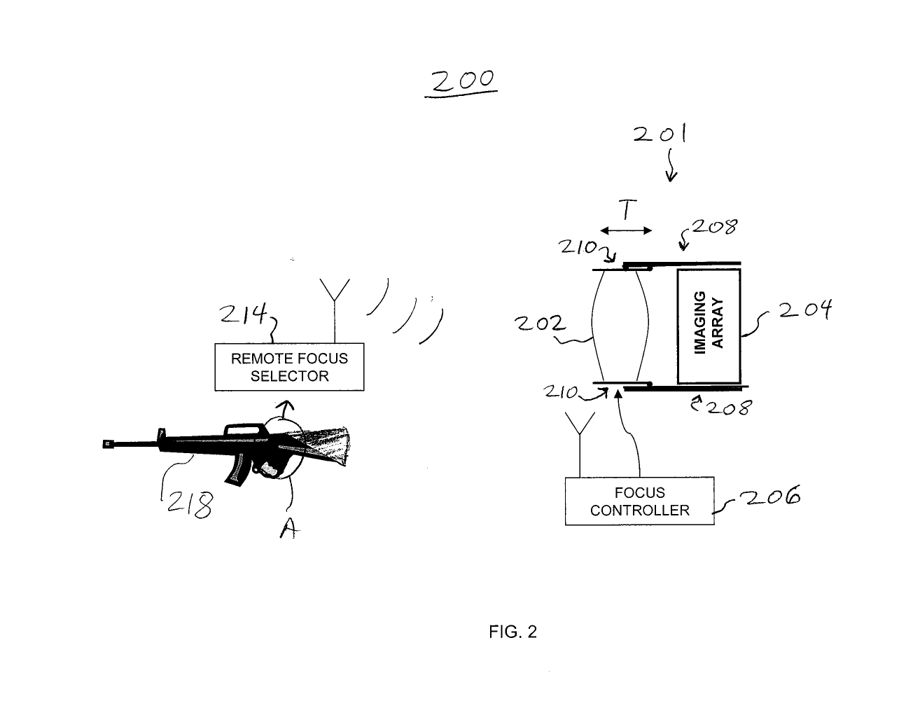

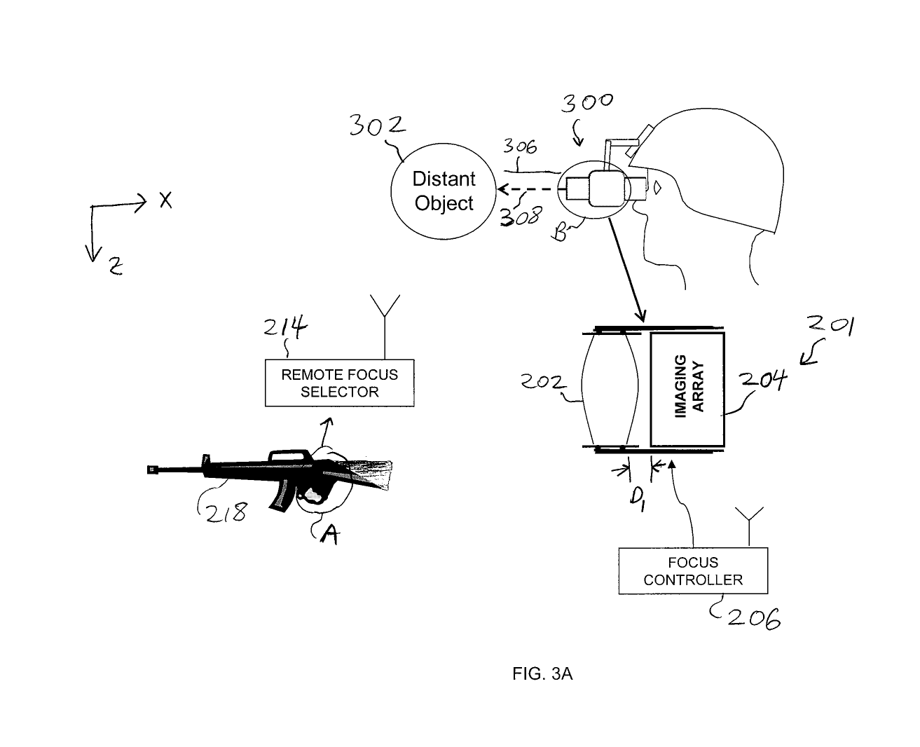

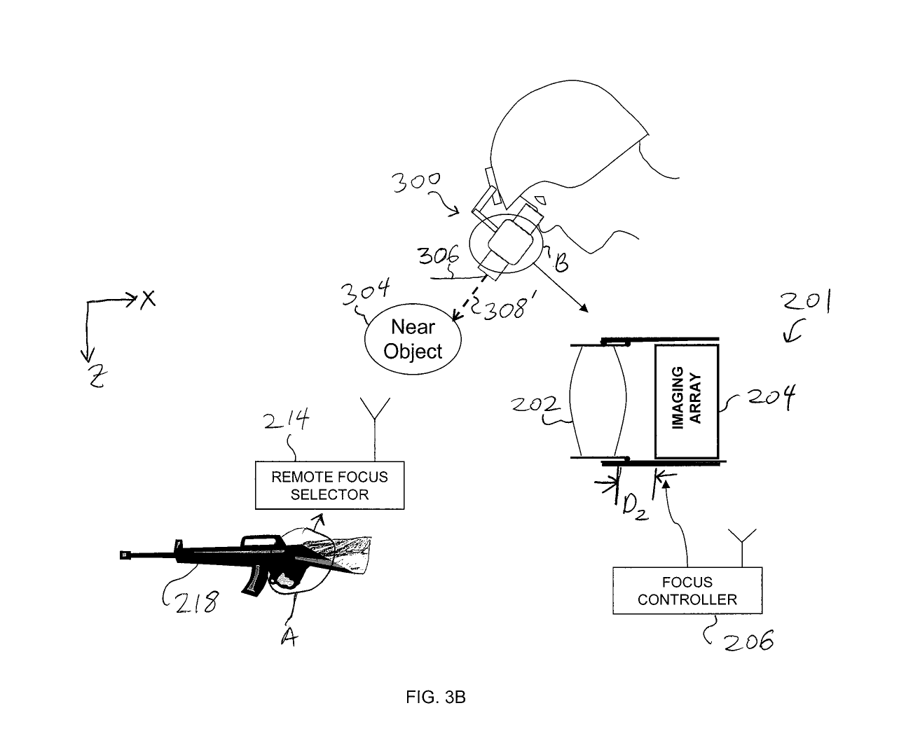

Referring next to FIG. 2, there is shown a remote focusing system for providing focusing, generally designated as 200. System 200 includes focusing device 201 and remote focus selector 214. Remote focus selector 214, responsive to a user, wirelessly transmits a focus position to focus controller 206. Focus controller 206, in response to remote focus selector 214, translates objective lens assembly 202 to one of a number of focus positions (i.e., to provide continuous focus adjustment). According to another embodiment, objective lens assembly 202 may be translated to one of two positions, for example, a near position or a far position, described further below with respect to FIGS. 3A and 3B. In general, remote focus selector 214 may provide focus adjustment of objective lens assembly 202 by selecting among one of two or more focus positions.

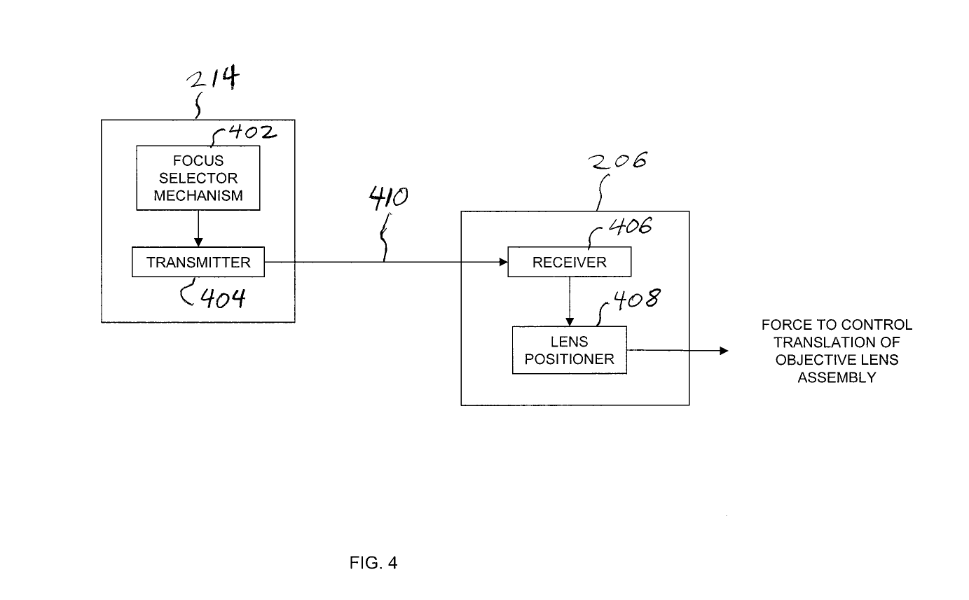

Remote focus selector 214 is coupled to manual device 218, such as a weapon, within a region of device 218 depicted as Section A. Remote focus selector 214 is desirably positioned on device 218 such that a user can select a focus position, without removing either hand from device 218. For example, if device 218 is a weapon, remote focus selector 214 may be positioned on the weapon such that it is easily reached by the fingers of the user but does not inhibit aiming or other operations of the weapon. Remote focus selector 214 may be permanently or temporarily coupled to device 218. For example, remote focus selector 214 may be attached to device 218 by a Velcro strap. Remote focus selector 214 is described further below with respect to FIG. 4.

Focusing device 201 may be used in a night vision optical device, such as night vision optical device 300 (shown in FIG. 3A). Focusing device 201 includes objective lens assembly 202, imaging array 204, and focus controller 206. Imaging array 204 is coupled to housing 208. Objective lens assembly 202 is mounted to lens translation mechanism 210 that is also coupled to housing. Thus, the objective lens assembly 202 translates along translation direction T relative to imaging array 204 via lens translation mechanism 210.

In operation, focus controller 206 receives focus positions from remote focus selector 214 and translates objective lens assembly 202 relative to imaging array 204 to one of a number of focus positions (e.g., two or more positions). It may be appreciated that focus controller 206, responsive to remote focus selector 214, may also translate objective lens assembly 202 relative to imaging array 204 to one of two discrete focus positions (e.g., a near position or a far position).

In general, objective lens assembly 202 may include one or several optical power elements, such as lens elements and/or mirrors, that are at fixed positions relative to each other within the overall objective lens assembly. Thus, lens translation mechanism 210 is illustrated as translating the entire objective lens assembly 202 relative to imaging array 204. According to another exemplary embodiment, objective lens assembly 202 may include one or more optical power elements that move relative to other optical power elements, in order to adjust the back focal distance to imaging array 204. In this embodiment, lens translation mechanism 210 may translate one or several optical power elements relative to other optical power elements within objective lens assembly 202, in order to provide the focusing described further below.

Imaging array 204 may include any suitable device for obtaining an image of an object, such as a CCD detector or CMOS detector. Lens translation mechanism 210 may be any suitable mechanism, such as a carriage to translate objective lens assembly 202 relative to imaging array 204. Focus controller 206 is described further below with respect FIG. 4.

Referring next to FIGS. 3A and 3B, cross-sections diagrams of focusing device 201 are shown as being a part of a Section B of night vision optical device 300. In particular, FIG. 3A shows the positioning of objective lens assembly 202 for distant object 302 (at back focal distance D₁), responsive to remote focus selector 214; and FIG. 3B illustrates positioning of objective lens assembly 202 for near object 304 (at back focal distance D₂), responsive to remote focus selector 214. Although two focus positions are illustrated in FIGS. 3A and 3B, it can be appreciated that remote focus selector 214 may select from a number of focus positions, to position objective lens assembly 202 to one of a corresponding number of back focal distances.

In FIG. 3A, night vision optical device 300 is directed toward distant object 302 with a line of sight (LOS) that is substantially parallel to a horizontal direction 306 (i.e., night vision optical device 300 has a horizontal LOS). In this case, a user selects a focus position corresponding to a far focus position via remote focus selector 214 and transmits the focus position to focus controller 206. Focus controller 206, responsive to remote focus selector 214, positions objective lens assembly 202 at distance D₁ relative to imaging array 204. The distance D₁ represents a first focus position (i.e., a far focus position) for objective lens assembly 202.

In FIG. 3B, night vision optical device 300 is oriented at LOS 308′ that is directed to near object 304. In this case, a user selects a focus position corresponding to a near focus position via remote focus selector 214. Responsive to the user, remote focus selector 214 transmits the near focus position to focus controller 206. Responsive to remote focus selector 214, focus controller 206 positions objective lens assembly 202 at distance D₂ relative to imaging array 204. The distance D₂ represents a second focus position (i.e., a near focus position of objective lens assembly 202).

According to an embodiment of the present invention, the first and second focus positions are selected by a user using remote focus selector 214 that is coupled directly to device 218. Accordingly, the first focus position may be remotely selected by remote focus selector 214 when the user determines that he is observing a distant object 302. The second focus position may be selected by a user via remote focus selector 214 when the user determines that he is observing a near object 304.

In a typical scenario, the soldier may want an infinity focus when looking along a horizontal LOS at far objects. The infinity focus position of conventional night vision devices typically allows for clear viewing of far targets and scenes and supports a general mobility task. If the soldier needs to observe a near obstacle, (such as a log or a ditch during movement), however, it is not convenient or feasible to repeatedly adjust the focus of the conventional manual device between a near and far position. In those cases, the soldier typically leaves the focus of the conventional manual device in the far position and gets a highly defocused image of the near obstacle when the night vision optical device is momentarily aimed down at the area in front of his feet. In general, a near focus of about a five feet is typically used in order to support maneuvering around and through obstacles. The user typically cannot afford the time and distraction caused by removing a hand from the weapon to perform a focus adjustment suitable to the immediate need.

The present invention provides at least two objective lens focus positions for a solider. According to one embodiment, remote focus selector 214 and focus controller 206 allows for continuous focusing via manual device 218. According to another embodiment, the present invention allows for remote selection between two focus positions, without requiring the solider to remove his hands from manual device 218 to adjust the focus. The remote focusing of the present invention may be useful for a dismounted solider for both viewing of far targets and scenes and for maneuvering around near obstacles.

Referring to FIG. 4, exemplary focus controller 206 and remote focus selector 214 are shown. Remote focus selector 214 includes focus selector mechanism 402 for selecting a focus position and transmitter 404 for transmitting the focus position to focus controller 206.

Focus selector mechanism 402 may include, any suitable mechanism, such as a knob or a switch, for selecting a focus position. For example, focus selector mechanism 402 may include a knob for selecting among a number of focus positions, to provide continuous adjustment of objective lens assembly 202 (FIG. 2).

As another example, focus selector mechanism 402 may include a three-position switch having a far focus switch position, a near focus switch position and a neutral switch position. When the three-position switch is positioned in the neutral switch position, no selection is made and, thus, no transmission is sent from transmitter 404. When the switch is positioned in the near focus switch position, focus selector mechanism 402 causes transmitter 404 to transmit a signal corresponding to the near focus position. When the switch is positioned in the far focus switch position, focus selector mechanism 402 causes transmitter 404 to transmit a signal corresponding to a far focus position. Accordingly, focus selector mechanism 402 may provide discrete adjustment of the objective lens assembly 202 (FIG. 2) relative to imaging array 204.

As yet another example, focus selector mechanism 402 may include a rocker switch. In operation, a user may hold the switch in a first position until objective lens assembly 202 (FIG. 2) is adjusted to be sufficiently focused to a suitable far focus position. Alternatively, the user may hold the switch in a second position until objective lens assembly 202 (FIG. 2) is adjusted to be sufficiently focused at a suitable near focus position. The rocker switch may also include a neutral switch position such that no transmissions are sent from transmitter 404 when the switch is positioned in the neutral switch position. Accordingly, focus selector mechanism 402 may provide remote continuous adjustment of the objective lens assembly 202 (FIG. 2) relative to imaging array 204.

Transmitter 404 may include any suitable device for wirelessly transmitting signal 410 representing the focus position selected by focus selector mechanism 402. Transmitter 404 may include, for example a low power radio frequency (RF) transmitter or a photonic transmitter, such as an infrared (IR) transmitter. Remote focus selector 214 may also encode the focus position by a suitable encoding process prior to wireless transmission of signal 410 representing the focus position.

Focus controller 206 includes receiver 406 and lens positioner 408. Receiver 406 receives signal 410 representing the focus position from transmitter 404 and provides the focus position to lens positioner 408. Receiver 406 may include any suitable device for receiving signal 410 wirelessly transmitted from remote focus selector 214. Examples of a suitable receiver 406 include an RF receiver or a photonic receiver, such as an IR receiver.

According to an exemplary embodiment, signal 410 may be encoded by transmitter 404. Receiver 406 may receive the encoded signal 410 from transmitter 404 and decode the encoded signal to obtain the selected focus position. It may be appreciated that transmitter 404 and receiver 406 may respectively encode and decode signal 410 representing the focus position to prevent additional signals (e.g., from additional remote focus selectors 214 associated with other users) from inadvertently adjusting the focus of focusing device 201.

Lens positioner 408 receives the focus position setting from focus selector mechanism 402 via receiver 406 and provides a force to control translation of objective lens assembly 202 (FIG. 2), via lens translation mechanism 210 (FIG. 2). It is understood that lens positioner 408 may include electrical and/or mechanical components to translate objective lens assembly 202 (FIG. 2). For example, lens positioner 408 may include a piezoelectric motor to drive lens translation mechanism 210 (FIG. 2). The translation of objective lens assembly 202 (FIG. 2) may be determined, for example, from a look-up table (LUT), based on predetermined focus positions.

Lens positioner 408 may include a microcontroller (not shown). The microcontroller may be any type of controller (e.g., a microprocessor or a field programmable gate array (FPGA)) having a processor execution capability provided by a software program stored in a non-transitory computer readable medium, or a hardwired program provided by an integrated circuit. The microcontroller may convert the focus position received from remote focus selector 214 into a force to control translation of objective lens assembly 202 (FIG. 2), via lens translation mechanism 210 (FIG. 2).

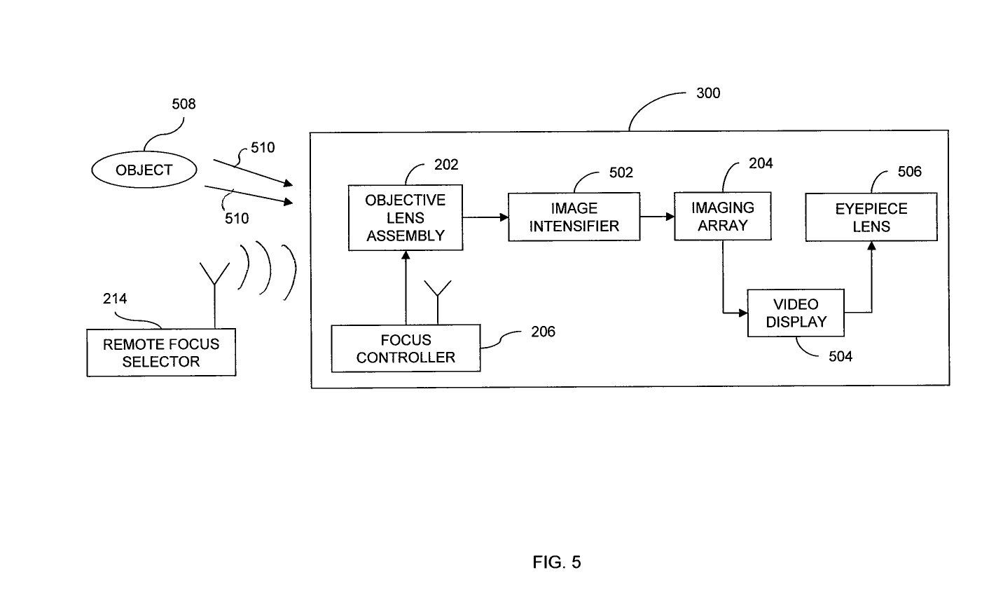

Referring to next to FIG. 5, a block diagram of an exemplary night vision optical device 300 is shown. Night vision optical device 300 includes objective lens assembly 202, focus controller 206, image intensifier 502, imaging array 204, video display 503 and eyepiece lens 506. Night vision optical device 300 may include other components, such as a high voltage power supply (HVPS).

Objective lens assembly 202 is positioned by focus controller 206 (responsive to remote focus selector 214) to receive light rays 510 from object 508 for one of two or more focus positions. Objective lens assembly 202 provides a focused image of a low light level scene to image intensifier 502, which may be powered by a HVPS. Image intensifier 502 amplifies the faint image at its input and reproduces a brighter version of this image on its output surface. This image is coherently transmitted to imaging array 204. Imaging array 204, which may be, for example, of a CMOS or CCD type, senses the intensified image and creates the real time video signal that contains a rendition of the image. The real time video signal is provided to video display 504. Video display produces an image of the scene which is presented to the user via eyepiece lens 506. Video display 504 may include, without being limited to, electronic displays (e.g., liquid crystal displays (LCDs), organic light emitting diode (OLED) displays, cathode ray tube (CRT) displays, electroluminescent displays (ELDs)), transparent reticles, or displays which provides an aerial image formed by a relay lens.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A focusing system for use with a night vision optical device, the focusing system comprising:
a focusing device including:
an objective lens assembly positioned among two or more focus positions from an imaging array, and
a focus controller, coupled to the objective lens assembly, configured to translate the objective lens assembly relative to the imaging array among the two or more focus positions; and
a focus selector, remote from the focusing device, configured to wirelessly transmit a selected focus position to the focus controller,
wherein the objective lens assembly is translated to one of the two or more focus positions in response to the selected focus position transmitted by the focus selector.

2. A focusing system according to claim 1, wherein the two or more focus positions includes a first focus position and a second focus position,
the first focus position is associated with an object positioned far from the objective lens assembly and the second focus position is associated with the object positioned substantially closer to the objective lens assembly.

3. A focusing system according to claim 1, wherein the focus selector is coupled to a device remote from the focusing device.

4. A focusing system according to claim 1, wherein the focus selector comprises:
a focus selector mechanism configured to select the one of the two or more focus positions, responsive to a user; and
a transmitter coupled to the focus selector mechanism, configured to wirelessly transmit the selected focus position to the focus controller.

5. A focusing system according to claim 4, wherein the transmitter includes at least one of a radio frequency (RF) transmitter or a photonic transmitter.

6. A focusing system according to claim 4, wherein the two or more focus positions includes a first focus position and a second focus position,
the focus selector mechanism includes a three-position switch configured to select either the first focus position, the second focus position or a neutral position, the neutral position associated with no transmission of either the first focus position or the second focus position.

7. A focusing system according to claim 4, wherein the two or more focus positions includes a first set of focus positions and a second set of focus positions,
the focus selector mechanism includes a rocker switch configured to select either a first switch position or a second switch position, and
the first switch position selects among the first set of focus positions and the second switch position selects among the second set of focus positions.

8. A focusing system according to claim 4, wherein the focus selector includes a knob configured to select among the two or more focus positions.

9. A focusing system according to claim 4, wherein the transmitter is configured to encode the selected focus position and transmit the encoded focus position.

10. A focusing system according to claim 1, wherein the focus controller includes:
a receiver configured to receive the selected focus position transmitted by the focus selector; and
a lens positioner coupled to the objective lens assembly for translating the objective lens assembly responsive to the received focus position.

11. A focusing system according to claim 10, wherein the transmitted focus position is encoded and the receiver is configured to decode the encoded focus position.

12. A focusing system according to claim 10, wherein the receiver includes at least one of a radio frequency (RF) receiver or a photonic receiver.

13. A night vision optical device comprising:
an objective lens assembly positioned among two or more focus positions from an imaging array; and
a focus controller, coupled to the objective lens assembly including:
a receiver configured to receive a selected focus position wirelessly transmitted from a focus selector that is remote from the focus controller, and
a lens positioner coupled to the objective lens assembly for translating the objective lens assembly responsive to the received focus position,
wherein the focus controller is configured to translate the objective lens assembly relative to the imaging array to one of the two or more focus positions responsive to the received focus position.

14. A night vision optical device according to claim 13, further including an image intensifier positioned between the objective lens assembly and the imaging array.

15. A night vision optical device according to claim 13, wherein the two or more focus positions includes a first focus position and a second focus position,
the first focus position is associated with an object positioned far from the objective lens assembly and the second focus position is associated with the object positioned substantially closer to the objective lens assembly.

16. A night vision optical device according to claim 13, wherein the selected focus position corresponds to one of the two or more focus positions.

17. A night vision optical device according to claim 13, further including:
an eyepiece lens assembly; and
a video display for receiving image data from the imaging array and displaying the image data to a user's eye via the eyepiece lens assembly.

18. A night vision optical device according to claim 13, wherein the selected focus position is encoded and the focus controller is configured to decode the encoded focus position.

19. A method for controlling a focal position of an objective lens assembly positioned from an imaging array in a focusing device of a night vision optical device, the method comprising:
(a) wirelessly signaling one of two or more focus positions to the focusing device from a device remote from the night vision optical device;
(b) receiving the signaled focus position by the focusing device; and
(c) translating the objective lens assembly relative to the imaging array to the received focus position.

20. The method according to claim 19, wherein the two or more focus positions include a first focus position and second focus position,
signaling the first focus position corresponds to focusing the objective lens assembly to an object positioned far from the objective lens assembly, and
signaling the second focus position corresponds to focusing the objective lens assembly to the object positioned substantially closer to the objective lens assembly.

21. The method according to claim 20, wherein step (a) includes:
(a1) selecting either the first focus position or the second focus position; and
(a2) signaling the selected focus position to the focusing device.

22. The method according to claim 19, wherein the method includes repeating steps (a)-(c) by signaling a different one of the two or more focus positions.

23. The method according to claim 19, wherein step (a) includes:
(a1) selecting the one of the two or more focus positions as a selected focus position;
(a2) encoding the selected focus position; and
(a3) wirelessly signaling the encoded focus position to the focusing device.

24. The method according to claim 23, wherein step (b) includes:
(b1) receiving the encoded focus position wirelessly signaled in step (a3); and
(b2) decoding the encoded focus position received in step (b1),
wherein the objective lens assembly is translated using the decoded focus position.
